(19) United States
(12) Patent Application Publication
(10) Pub. No.: US 2026/0208590 A1
(43) Pub. Date: Jul. 23, 2026

(54) MODULAR DASHBOARDS FOR PERSONAL TRANSPORTATION VEHICLES

(71) Applicant: CLUB CAR, LLC, Evans, GA (US)

(72) Inventors: Grady William Stafford Hall, Evans, GA (US); Greg Lacock, Augusta, GA (US); Michael Edward Lorentz, Evans, GA (US); Hayden Adam Lynch, Harlem, GA (US); Brian Scarborough, Garfield, GA (US); Nikolas Bryan-Dunaway, Grovetown, GA (US)

(21) Appl. No.: 19/029,818

(22) Filed: Jan. 17, 2025

(51) Int. Cl. B60K 37/10; B60K 37/20

(52) U.S. Cl. CPC B60K 37/10; B60K 37/20; B60K 2360/1438

(57) ABSTRACT

An embodiment of a dashboard for a personal transportation vehicle includes a control port and one or more mounting structures positioned in the control port. The control port is configured to receive one of a plurality of instrument panels therein. In addition, each of the plurality of instrument panels includes a unique configuration of one or more control components for operation of the personal transportation vehicle. Further, each of the plurality of controls modules is configured to be secured within the controls port via at least one of the one or more mounting structures.

### CROSS-REFERENCE TO RELATED APPLICATIONS

Not applicable.

### BACKGROUND

Personal transportation vehicles may be used for a variety of purposes. For instance, a personal transportation may include a golf cart that is used for transporting golfers and their carts around a golf course. As another example, a personal transportation vehicle may include a utility vehicle that an individual may use to transport personnel and/or tools and equipment around a property or facility. In still other examples, a personal transportation vehicle may include a cart that may be used by individuals or families for short range transportation in a local area, such as a residential neighborhood, an apartment or condominium complex, and the like. In all of these examples, these different personal transportation vehicles may share a common drivetrain and frame, but may be outfitted with unique finishings and components that are tailored for the intended use of the vehicles.

### BRIEF SUMMARY

Some embodiments disclosed herein are directed to a dashboard for a personal transportation vehicle. In some embodiments, the dashboard includes a control port and one or more mounting structures positioned in the control port. The control port is configured to receive one of a plurality of instrument panels therein. In addition, each of the plurality of instrument panels include a unique configuration of one or more control components for operation of the personal transportation vehicle. Further, each of the plurality of controls modules is configured to be secured within the controls port via at least one of the one or more mounting structures.

Some embodiments disclosed herein are directed to a personal transportation vehicle. In some embodiments, the personal transportation vehicle includes a plurality of wheels, a body supported by the plurality of wheels, and at least one seat coupled to the body. In addition, the personal transportation vehicle includes a dashboard positioned to oppose the at least one seat. The dashboard includes a control port and one or more mounting structures positioned in the control port. The control port is configured to receive one of a plurality of instrument panels therein. In addition, each of the plurality of instrument panels includes a unique configuration of one or more control components for operation of the personal transportation vehicle. Further, each of the plurality of controls modules is configured to be secured within the controls port via at least one of the one or more mounting structures.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those having ordinary skill in the art upon reading the following detailed description, and by referring to the accompanying drawings. It should be appreciated that this disclosure may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various embodiments, reference will now be made to the accompanying drawings in which:

FIG. 1 is a perspective view of a personal transportation vehicle including a modular dashboard according to some embodiments disclosed herein;

FIG. 2 is a schematic view of the modular dashboard of the vehicle of FIG. 1 according to some embodiments disclosed herein;

FIG. 3 is a perspective view of the modular dashboard of the vehicle of FIG. 1 including an instrument panel therein according to some embodiments disclosed herein;

FIG. 4 is a perspective view of the modular dashboard of the vehicle of FIG. 1, showing an instrument panel exploded out of a control port of the dashboard according to some embodiments disclosed herein;

FIGS. 5A-5E are front views of different unique instrument panels that may be installed in the control port of the modular dashboard of the vehicle of FIG. 1 according to some embodiments disclosed herein;

FIGS. 6 and 7 are perspective, partially exploded views of a compartment assembly that may be installed in the control port of the modular dashboard of FIG. 1 according to some embodiments disclosed herein;

FIG. 8 is a perspective view of the modular dashboard of the vehicle of FIG. 1 including an instrument panel therein according to some embodiments disclosed herein;

FIG. 9 is a partially exploded view of a cover panel that may be installed within the control port of the modular dashboard of the vehicle of FIG. 1 to correspond to the instrument panel of FIG. 8 according to some embodiments disclosed herein;

FIG. 10 is a perspective, rear view of the instrument panel of FIG. 8 according to some embodiments disclosed herein; and

FIG. 11 is a perspective, partially exploded view of a compartment assembly that may be installed in the control port of the modular dashboard of FIG. 1 according to some embodiments disclosed herein.

### DETAILED DESCRIPTION

A personal transportation vehicle may be placed in a number of different configurations depending on the use and function of the vehicle by the user. Example uses of a personal transportation vehicle may include as a golf cart, a utility vehicle, or a local shortrange transportation vehicle as previously described. However, while each of these example personal transportation vehicles may share common drivetrains and/or frames (or chassis), each of these example transportation vehicles may include unique and finishings and components that are configured to support their unique intended uses. For instance, each of these example personal transportation vehicles may have unique instrument panels that are specifically configured for the intended use of the vehicle. In addition, even if two personal transportation vehicles are utilized for the same or a similar purpose as previously described (e.g., as a golf cart, utility vehicle, shortrange transportation vehicle, etc.), each of these two personal transportation vehicles may have different trims or model designations that each have a unique set of controls, features, or other assemblies that may call for a unique instrument panel. Regardless, the use of these different instrument panels may require unique components and manufacturing steps that further increase the manufacturing complexity and costs for a personal transportation vehicle.

Accordingly, embodiment disclosed herein include modular dashboards that are configured to be placed in a plurality of different configurations in order to facilitate the manufacturing (or converting) of a personal transportation vehicle in (or to) a number of different configurations. For instance, in some embodiments, the modular dashboards of the embodiments disclosed herein may include a controls port that may receive a plurality of unique instrumental panels therein. Thus, a manufacturer of personal transportation vehicles may stock a single dashboard for personal transportation vehicles that are ultimately to be placed in a number of different configurations. As a result, the number of unique manufacturing components and steps may be minimized so that the overall manufacturing process for personal transportation vehicles may be more streamlined.

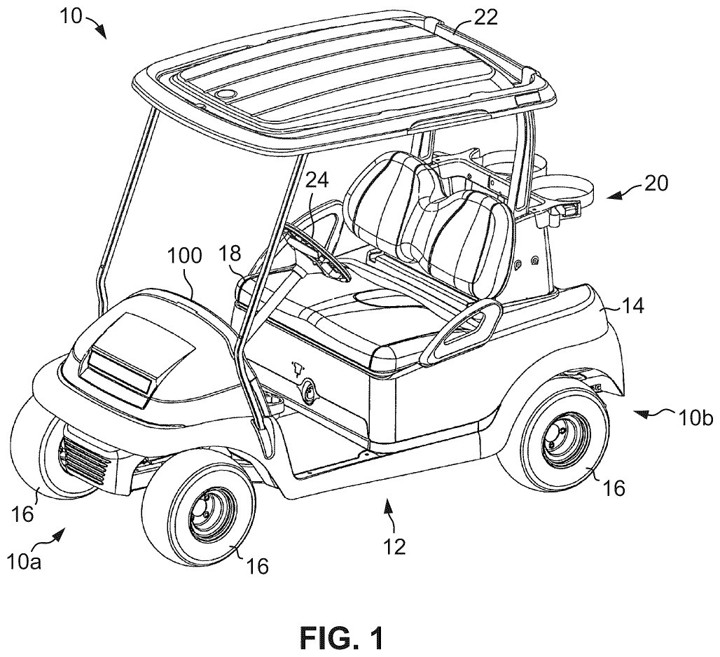

Referring now to FIG. 1, a personal transportation vehicle 10 including a modular dashboard 100 according to some embodiments disclosed herein is shown. The personal transportation vehicle 10 illustrated in FIG. 1 is configured for use as a golf-cart; however, the personal transportation vehicle 10 may be configured for different uses in other embodiments (e.g., as a utility vehicle, a shortrange transportation vehicle, etc.). Thus, the depiction of the personal transportation vehicle 10 as a golf-cart is merely for illustration and is not limiting to other embodiments of personal transportation vehicle 10.

The personal transportation vehicle 10 (or more simply “vehicle 10”) may be an electric vehicle that is driven by one or more electric motors. Alternatively, in some embodiments, the vehicle 10 may comprise a fossil-fuel operated vehicle that is driven by an internal combustion engine. In some embodiments, the vehicle 10 may comprise a so-called “hybrid” vehicle that is driven by both one or more electric motors and an internal combustion engine.

The vehicle 10 includes a first or front end 10a and a second or back end 10b that is opposite the front end 10a. In addition, the vehicle 10 may include a chassis or frame 12, a plurality of wheels 16 coupled to the frame 12 so that the frame 12 is suspended above the ground via the wheels 16. Further, the vehicle 10 includes a body 14 that is coupled to the frame 12 and therefore supported by the wheels 16.

One or more seats 18 may be coupled to the body 14 so that the modular dashboard 100 opposes the one or more seats 18. In addition, a roof 22 may be connected to the body 14 to provide a top cover for the users or passenger(s) of the vehicle 10 during operations. Because the vehicle 10 is configured as a golf-cart, the body 14 may also include a golf bag storage assembly 20 that is positioned at or proximate the back end 10b of the vehicle 10.

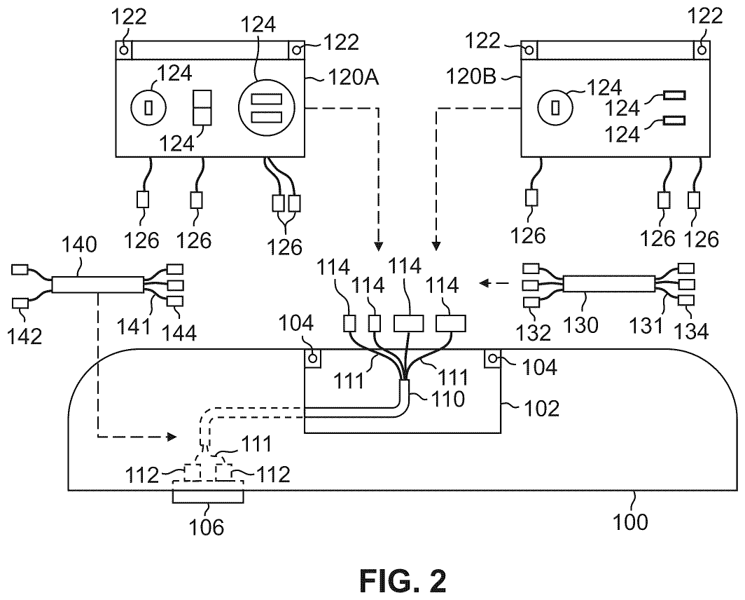

The vehicle 10 may also include a plurality of controls that may be used by a user for operation of the vehicle 10. For instance, the vehicle 10 may include a steering wheel 24 that is accessible from at least one of the seats 18. In addition, the vehicle 10 may support a number of control components (not shown in FIG. 1, but see control components 124 shown in FIG. 2) in the modular dashboard 100 that also may be visible and accessible from the at least one of the seats 18.

As used herein, a “control component” may comprise any suitable device that is configured to output information to a user or that is configured to receive inputs from a user to facilitate operation of a personal transportation vehicle or a sub-assembly of or coupled thereto. For instance, a “control component” may include an analogue or digital informational readout, such as a speedometer, battery life indicator, indicator light, etc., a user interface, such as a touch-sensitive panel or display, a button, a knob, a switch (including a vehicle start switch), etc., an interactive device, such as a computing device, a stereo, a radio, a music player, etc., or one or more devices that comprise various combinations of the above-listed examples.

Referring still to FIG. 1, the modular dashboard 100 (or more simply “dashboard” 100) may be configured to receive a plurality of different selections, arrangements, or configurations of control components via a plurality of unique instrument panels that are each configured to correspond with a plurality of different configurations of vehicle 10. Thus, the dashboard 100 may be common to each of these different configurations, so that the manufacturing of vehicle 10 may be more streamlined.

Referring now to FIG. 2, a schematic illustration of the dashboard 100 of vehicle 10 in FIG. 1 is shown according to some embodiments. The schematic illustration of the dashboard 100 highlights the connection and integration of various unique instrument panels (such as example instrument panels 120A, 120B). Thus, other components or features of the dashboard 100, such as various cup holders, compartments, shelves, etc., are not represented in FIG. 2 in order to simplify the drawings.

As shown in FIG. 2, the dashboard 100 includes a control port 102 that is configured to receive a plurality of instrument panels 120A, 120B therein for the operation of the vehicle 10 (FIG. 1). Two unique instrument panels 120A, 120B (including a first instrument panel 120A and a second instrument panel 120B) are illustrated in FIG. 2 as examples; however, as will be described in more detail herein, the control port 102 may receive a large number of unique instrument panels 120A, 120B, each having a unique selection, arrangement, and/or configuration of control components 124.

The control port 102 may include one or more mounting structures 104 to facilitate the connection to the instrument panels 120A, 120B. For instance, as shown in FIG. 2, the one or more mounting structures 104 of control port 102 may include a pair of mounting brackets that are configured to engage with corresponding mounting brackets 122 on the instrument panels 120A, 120B. Specifically, the one or more mounting structures (brackets) 104 of the control port 102 and the mounting brackets 122 of the instrument panels 120A, 120B may include holes or other apertures that may be aligned so as to receive an elongate mounting member (e.g., a screw, bolt, rivet, pin, etc.) therethrough and secure the instrument panels 120A, 120B in the control port 102.

Each instrument panel 120A, 120B may include a unique configuration of control components 124, including a unique selection and arrangement of control components 124. Specifically, the instrument panel 120A includes a first configuration of control components 124, and the instrument panel 120B includes a second configuration of control components 124. The first configuration of control components for the first instrument panel 120A may include one or more of different selections or different arrangements of control components 124 relative to the second configuration of control components for the second instrument panel 120B. The first and second configurations of control components 124 for the instrument panels 120A, 120B may be arranged to provide different types of information and/or control over different components or systems that may be associated with different configurations of the vehicle 10 as previously described.

A wire harness 110 may be connected to one or more connectors 106 of the vehicle 10 and routed to the control port 102. The wire harness 110 may include one or more wires or other conductors 111 (such as fiber optic cables, coaxial cable, metallic wires, etc.), a first set of connectors 112, and a second set of connectors 114. The first set of connectors 112 and the second set of connectors 114 are connected to the wires 111, such that the first set of connectors 112 are connected to one end of the wires 111 and the second set of connectors 114 are connected to a second, opposite end of the wires 111. The number of connectors 112 may be equal to or different from the number of connectors 114. For instance, some of the wires may be spliced together between the connectors 112, 114 so that there are fewer connectors 112 than connectors 114 (or vice versa).

The first set of connectors 112 may be connected to the one or more connectors 106 mounted within the vehicle 10, so that the wires 111 of wire harness 110 may be connected to one or more sensors, systems, controllers, or other components of the vehicle 10. In addition, the second set of connectors 114 may be positioned in or accessible from the control port 102. The second set of connectors 114 may be connected to corresponding connectors 126 of each of the instrument panels 120A, 120B. Specifically, each of the control components 124 of the instrument panels 120A, 120B may be connected to one or more of the connectors 126 by suitable wires or other conductors.

When a selected one of the instrument panels 120A, 120B is installed in the control port 102, the connectors 126 may be connected to the second set of connectors 114 (or at least some of the second set of connectors 114) so as to connect the control components 124 to the appropriate sensors, systems, controllers, or other components of the vehicle 10 via the wire harness 110 and connected connectors 112, 106. In some embodiments, the second set of connectors 114 may correspond to the connectors 126 of at least one (or perhaps both) of the instrument panels 120A, 120B.

In some embodiments, an adapter wire harness 130 may be employed in order to connect the second set of connectors 114 on the wire harness 110 to the connectors 126 on at least one of the instrument panels 120A, 120B. The adapter wire harness 130 (or more simply “adapter 130”) may include a plurality of wires 131 that are connected between a first set of connectors 132 and as second set of connectors 134. The first set of connectors 132 may connect to the second set of connectors 114 on the wire harness 110, and the second set of connectors 134 may connect to the connectors 126 on at least one of the instrument panels 120A, 120B.

In some embodiments, the wire harness 110 may be replaced with a second wire harness 140 in order to facilitate connection of the connectors 126 of at least one of the instrument panels 120A, 120B to the appropriate sensors, systems, controllers, or other components of the vehicle 10 via the connectors 106. Like the wire harness 110, the second wire harness 140 may include a plurality of wires 141 that are connected between a first set of connectors 142 and as second set of connectors 144. The first set of connectors 142 may be connected to the connectors 106 of the vehicle 10 (FIG. 1) in place of the connectors 112 of wire harness 110, and the second set of connectors 144 may be connected to the connectors 126 on at least one of the instrument panels 120A, 120B and/or the connectors 132 of the adapter 130 (or another adapter).

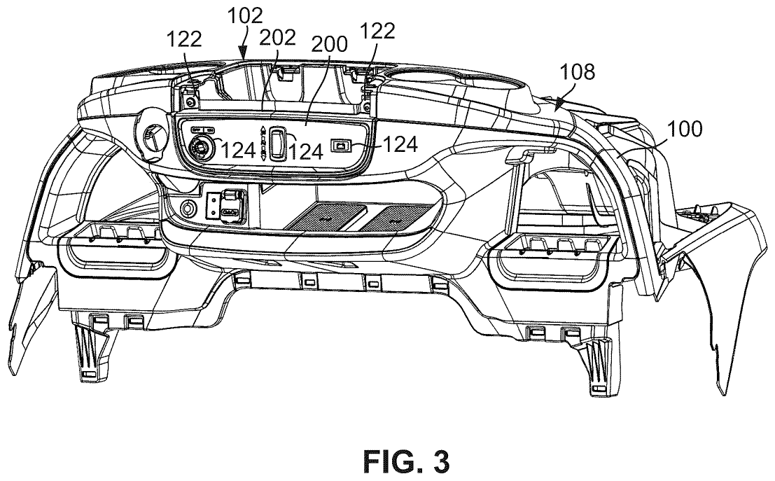

Referring now to FIG. 3, an example of the dashboard 100 is shown with an instrument panel 200 installed in the control port 102 according to some embodiments. As previously described for the instrument panels 120A, 120B of FIG. 2, the instrument panel 200 may comprise a unique configuration of control components 124. For instance, for the instrument panel 200, the control components 124 include a key-operated start switch, a forward-reverse switch, and a battery indicator light (however, other configurations of control components 124 are contemplated). The instrument panel 200 may be secured in the control port 102 via the mounting bracket(s) 122 and mounting structures 104 (FIG. 2) as previously described.

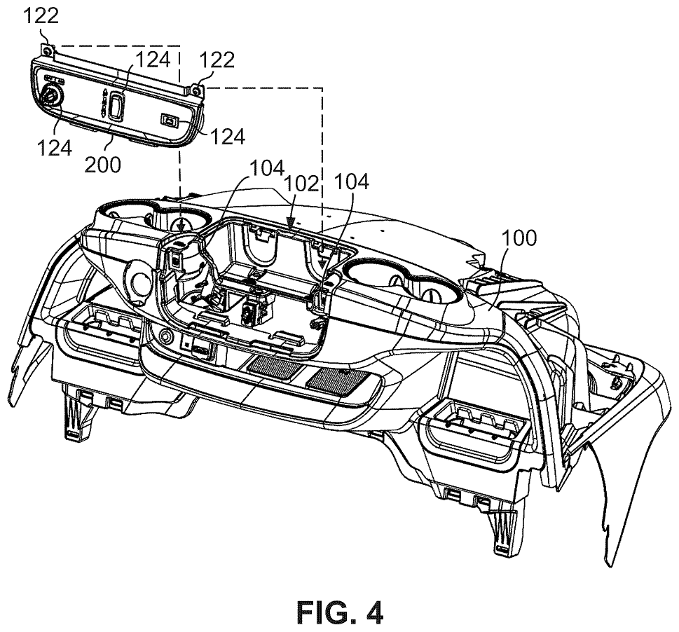

Specifically, with reference to FIG. 4, the instrument panel 200 may include the pair of mounting brackets 122 that correspond and connect to the one or more mounting structures (brackets) 104 defined in the control port 102. At least some instrument panels that may be mounted in the control port 102 (such as instrument panel 200) may include similar corresponding mounting brackets 122 that may correspond with the one or more mounting structures 104 (brackets 104) so that the various, unique instrument panels (e.g., instrument panel 200) may be secured in the control port 102 as previously described.

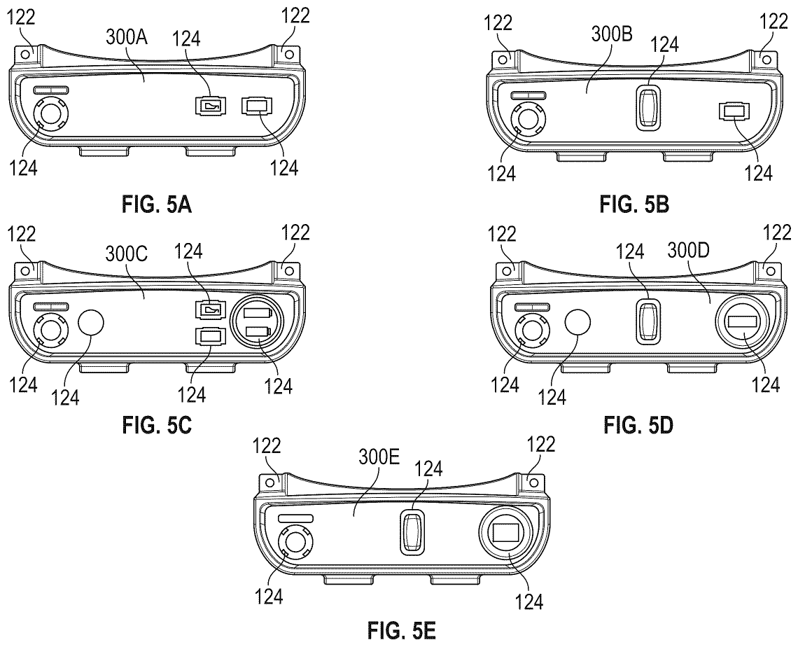

FIGS. 5A-5E show additional examples of instrument panels 300A-300E that are configured to be received and installed in the control port 102 via the mounting brackets 122 in place of the instrument panel 200 (FIGS. 3 and 4) as previously described. Each of the instrument panels 300A-300E includes a unique configuration of control components 124 as previously described. For instance, one of the control components 124 on each of the control panels 300A-300E is a key-operated start switch. In addition, one of the control components 124 on the instrument panels 300B, 300D, 300E in FIGS. 5B, 5D, 5E, respectively, is a forward-reverse switch. Further, one of the control components 124 of the instrument panels 300C, 300D, 300E in FIGS. 5C, 5D, 5E, respectively, may be a digital read-out. Still further, one or more of the control components 124 of the instrument panels 300A, 300B, 300C in FIGS. 5A, 5B, 5C may be indicator lights (such as a battery light, an engine oil light, etc.).

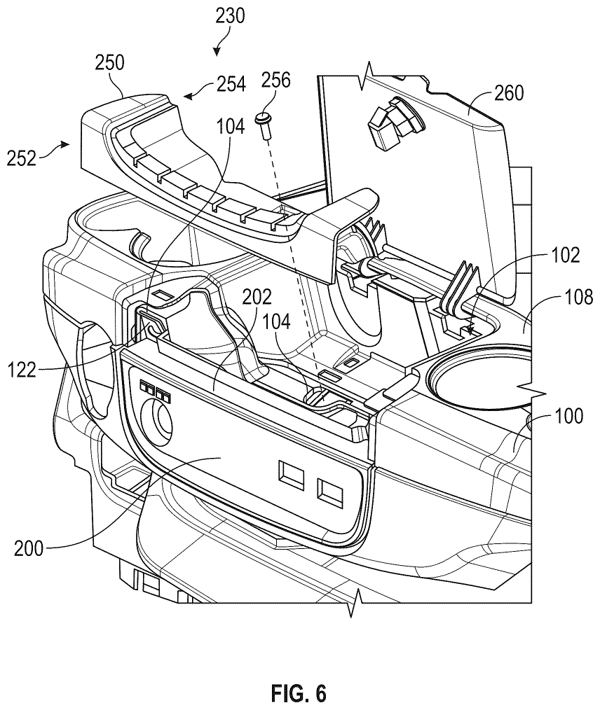

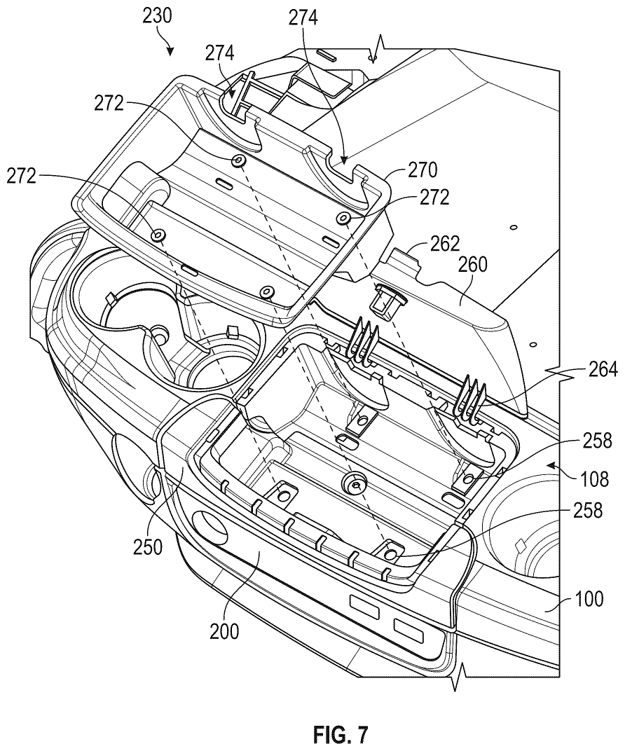

Referring now to FIGS. 6 and 7, in some embodiments, the control port 102 may also receive a compartment assembly 230 in addition to the modular instrument panel 200 (or any of the instrument panels 300A-300E as previously described). As shown in FIGS. 6 and 7, the compartment assembly 230 may be configured to engage with the instrument panel 200 inserted into the control port 102 to define a compartment along a top surface 108 of the dashboard 100.

The compartment assembly 230 may include a cover panel 250 and a compartment insert 270. The cover panel 250 may include a front or outer side 252 and a back or inner side 254. In addition, as shown in FIG. 6, the instrument panel 200 may define an upward facing ledge or shoulder 202 along a front side thereof. Once the instrument panel 200 is received and installed into the control port 102, the cover panel 250 may be inserted into the control port on top of the instrument panel 200 so that the outer side 252 may engage with the shoulder 202 and thereby at least partially cover the mounting brackets 122 and corresponding mounting structures (brackets) 104. The inner side 254 of the cover panel 250 may extend into the control port 102 from the top surface 108 of dashboard 100. An elongate connecting member 256, such as a screw or bolt, may be inserted through a corresponding aperture along the inner side 254 of the cover panel 250 and engaged into another, corresponding mounting structure 104 positioned in the control port 102, so as to secure and attach the cover panel 250 to the dashboard 100. The mounting structure 104 for receiving the mounting member 256 may comprise a suitable screw hole (or other aperture).

As shown in FIG. 7, after the cover panel 250 is installed into the control port 102 overtop of the instrument panel 200 as previously described, the compartment insert 270 may be inserted into the control port 102 from the top surface 108 of dashboard 100 to define a compartment for the compartment assembly 230. Specifically, the compartment insert 270 may include a plurality (such as four in the embodiment illustrated in FIG. 7) mounting apertures 272 that each align with corresponding mounting apertures 258 in the cover panel 250 and/or control port 102. For the embodiment illustrated in FIG. 7, the compartment insert 270 includes two mounting apertures 272 that align with mounting apertures 258 defined in the cover panel 250 and two mounting apertures 272 that align with mounting apertures 258 in the control port 102. Mounting members (e.g., screws, bolts, etc.) may be inserted through the aligned mounting apertures 272, 258 so as to secure the compartment insert 270 to the dashboard 100. The compartment defined by the compartment insert 270 may be used to hold personal items, such as cell phones, keys, golf balls, wallets, etc., of a user or passenger of the vehicle 10 (FIG. 1) during operation.

Referring still to FIGS. 6 and 7, the compartment assembly 230 may further include a compartment door 260 that is pivotably attached to the dashboard 100 at the control port 102 via one or more (such as a pair of) hinge members 264 that hook into suitable apertures (or other structures) defined on the dashboard 100 (such as in or along the control port 102). The compartment door 260 may be rotated relative to the dashboard via the hinge members 264 so as to at least partially close or occlude the compartment defined by the compartment insert 270. Specifically, the compartment door 260 may be configured to pivot relative to the dashboard 100 between a closed position in which the compartment door 260 is rotated downward to cover the compartment defined by the compartment insert 270 and an open position in which the compartment door is rotated upward from the closed position to expose the compartment defined by the compartment insert 270. In addition, as shown in FIG. 7, the compartment insert 270 may include one or more (such as a pair of) openings or slots 274 that provide suitable clearance for the hinge members 264 during rotation of the compartment door 260 to and between the open position and closed position.

The compartment door 260 may include a lock 262, such as a key-actuated lock, that may selectively lock the compartment in the closed position. Specifically, the lock 262 may selectively engage with a suitable slot or aperture(s) in one or both of the compartment insert 270 and the cover panel 250.

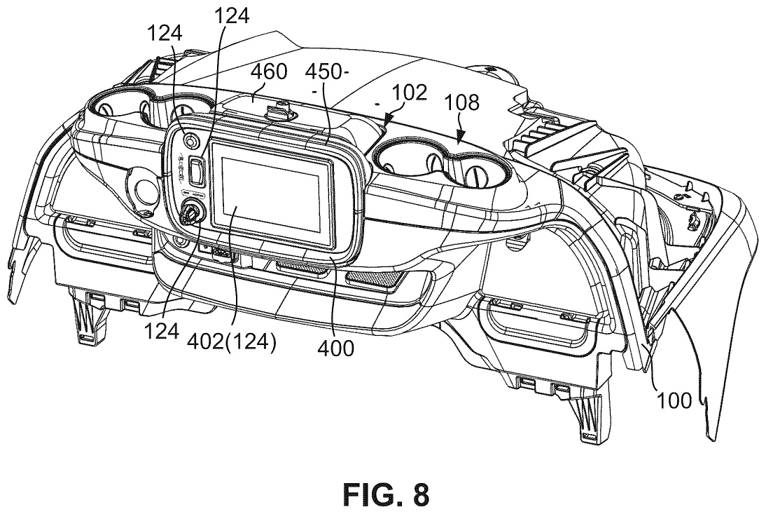

Referring now to FIG. 8, an example of the dashboard 100 is shown with an instrument panel 400 installed in the control port 102 according to some embodiments. The instrument panel 400 may have a substantially different footprint from the other example instrument panels 120A, 120B, 200, 300A-300E described herein. Specifically, the footprint of the instrument panel 400 may be larger than other instrument panels described herein (e.g., instrument panels 120A, 120B, 200, 300A-300E). As will be described in more detail, an alternative cover panel 450 may be used in place of the cover panel 250 (FIG. 6) to function as an adapter to facilitate the installation of the larger instrument panel 400 into the same control port 102 that may receive the smaller instrument panels described herein (e.g., instrument panels 120A, 120B, 200, 300A-300E).

As shown in FIG. 8, the instrument panel 400 may include a large electronic display 402 as at least one of the control components 124 included on the instrument panel 400. Specifically, the electronic display 402 may comprise any suitable type of electronic display, such as a liquid crystal display (LCD), a light-emitting diode display (e.g., an organic light-emitting diode display (OLED), in organic light-emitting diode display, etc.), or a plasma display. In some embodiments, the electronic display 402 may comprise a so-called “touch-sensitive” electronic display that is configured to detect user touches on the display 402 as inputs. The electronic display 402 may employ any suitable touch-sensitive technology, such as capacitive touch sensitivity, or resistive touch sensitivity. During operations, the electronic display 402 may display information (including graphics, images, video, etc.) relating to the operation of the vehicle 10 (FIG. 1) or other software applications (including entertainment applications, navigation applications, or others). Thus, the electronic display 402 may provide the functionality of one or more of the other example control components 124 that may be employed by other examples of an instrument panel described herein (e.g., instrument panels 300A-300E shown in FIGS. 5A-5E and previously described).

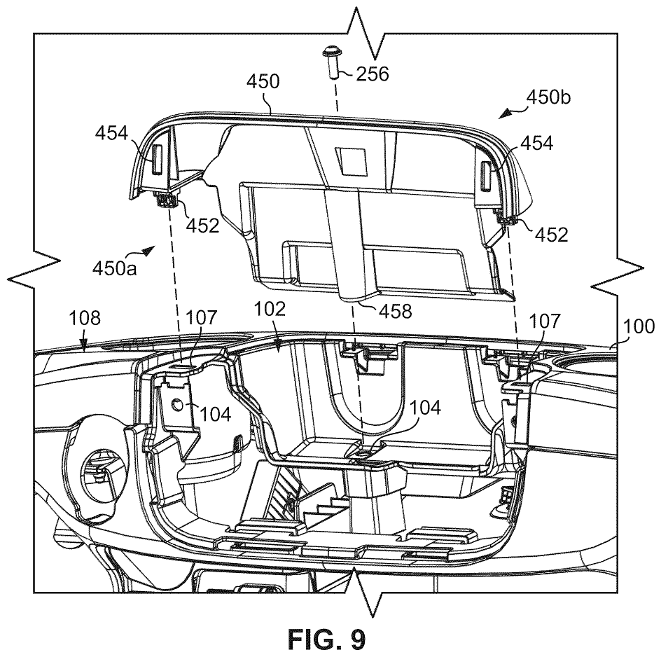

Referring now to FIG. 9, as previously described, an alternative cover panel 450 may be installed into the control port 102 in order to accommodate the larger instrument panel 400. Specifically, the cover panel 450 may include a front side 450a and a back side 450b. The front side 450a may face toward the instrument panel 400 (FIG. 8) when installed in the control port 102, and the back side 450b may be inserted into the control port 102, behind the instrument panel 400 (when installed). As previously described for the cover panel 250, the cover panel 450 may be secured to at least one mounting structure 104 in the control port 102 via an elongate mounting member 256. In addition, the cover panel 450 includes a pair of spring-loaded tabs 452 that are inserted into corresponding slots 107 defined in the control port 102 to further secure the cover panel 450 to the dashboard 100. The spring-loaded tabs 452 may snap into the slots 107 so as to restrict the removal thereof.

The cover panel 450 also defines one or more additional mounting structures 454 on the front side 450a. In the embodiment illustrated in FIG. 9, the mounting structures 454 comprise mounting slots that are similar to the slots 107 defined in the control port 102. However, other mounting structures, such as brackets, apertures, etc. are contemplated in various embodiments.

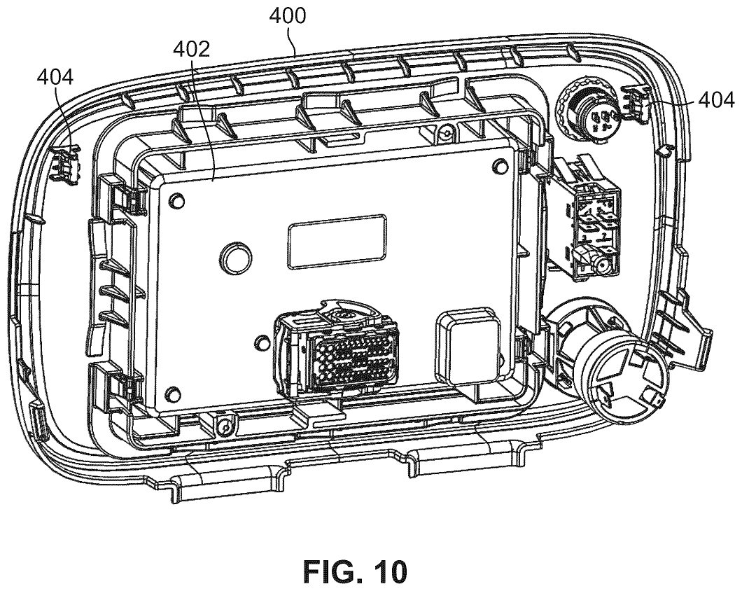

Referring now to FIGS. 8 and 10, a backside of the instrument panel 400 may include one or more (such as a pair) of spring-loaded tabs 404 that are configured to be inserted into the slots 454 defined on the front side 450a of cover panel 450. As is previously described for the spring-loaded tabs 452 and slots 107, the spring-loaded tabs 404 may snap into the slots 454 so as to restrict the removal thereof. Thus, the instrument panel 400 may be secured in the control port 102 via the cover panel 450, which is further secured to at least one of the mounting structures 104 in control port 102.

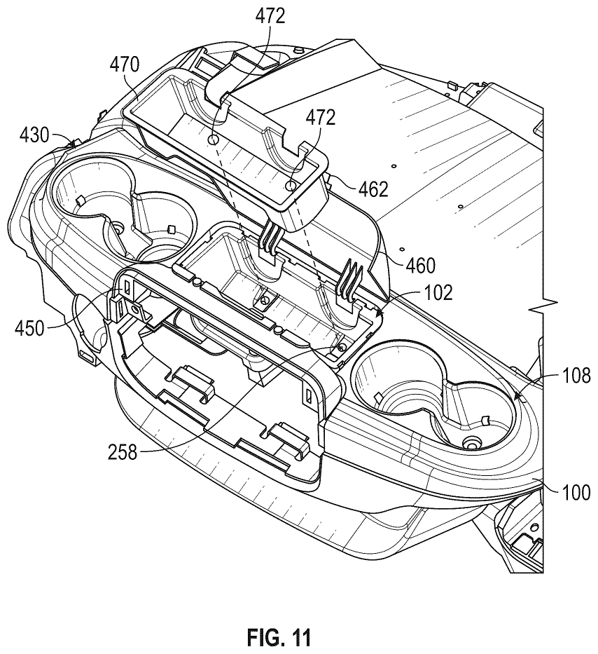

Referring now to FIG. 11, an alternative compartment assembly 430 may be installed into the control port 102 so as to define a compartment that corresponds to the instrument panel 400 and the cover panel 450. Specifically, the alternative compartment assembly 430 may include a compartment insert 470, and a compartment door 460. The compartment insert 470 may be secured into the control port 102 via one or more mounting apertures 472 that align with corresponding mounting apertures 258 in the control port 102 and/or cover panel 450 and receive a corresponding elongate mounting member in a similar manner previously described for mounting apertures 272, 258 for the compartment assembly 230 (FIG. 7).

In addition, the compartment assembly 430 includes a compartment door 460 that is pivotably coupled to the control port 102 in a similar manner to that described for the compartment door 260 (FIGS. 6 and 7). However, the compartment door 460 may be shaped and configured to correspond with the shape and configuration of the cover panel 450 and compartment insert 430. Thus, the compartment door 460 may be pivotable between a closed position between a closed position in which the compartment door 460 is rotated downward to cover the compartment defined by the compartment insert 430 and an open position in which the compartment door is rotated upward from the closed position to expose the compartment defined by the compartment insert 430. In addition, the compartment door 460 may include a lock 462, such as a key-actuated lock that may selectively lock the compartment in the closed position. Specifically, the lock 462 may selectively engage with a suitable slot or aperture(s) in one or both of the compartment insert 430 and the cover panel 450.

As explained above and reiterated below, the present disclosure includes, without limitation, the following example implementations.
Clause 1: A dashboard for a personal transportation vehicle, the dashboard comprising: a control port; and one or more mounting structures positioned in the control port, wherein the control port is configured to receive one of a plurality of instrument panels therein, each of the plurality of instrument panels including a unique configuration of one or more control components for operation of the personal transportation vehicle, and wherein each of the plurality of controls modules is configured to be secured within the controls port via at least one of the one or more mounting structures.
Clause 2: The dashboard of any of the clauses, wherein the one or more control components include at least one of an electronic display, an indicator light, and a switch.
Clause 3: The dashboard of any of the clauses, wherein the one or more mounting structures of the controls port comprises a pair of mounting brackets that align with corresponding mounting brackets on each of the plurality of instrument panels.
Clause 4: The dashboard of any of the clauses, further comprising a compartment assembly that is configured to engage with each of the plurality of instrument panels to define a compartment along a top surface of the dashboard.
Clause 5: The dashboard of any of the clauses, wherein the compartment assembly comprises: a cover panel that is configured to be secured to the dashboard at the control port so that the cover panel is configured to at least partially cover the pair of mounting brackets; and a compartment insert that is configured to be inserted into the control port and to be connected to the cover panel to define the compartment.
Clause 6: The dashboard of any of the clauses, wherein the compartment assembly further comprises a compartment door that configured to pivotably coupled to the dashboard along the top surface, and wherein the compartment door is configured to pivot relative to the dashboard between: a closed position in which the compartment door is rotated to engage with the compartment insert to cover the compartment; and an open position in which the compartment door is rotated upward from the closed position to expose the compartment.
Clause 7: The dashboard of any of the clauses, further comprising a compartment assembly that is configured to define a compartment along a top surface of the dashboard in the control port, wherein the compartment assembly comprises a cover panel that is configured to connect to at least one of the one or more mounting structures of the control port, and wherein the cover panel defines at least one additional mounting structure, and wherein the control port is configured to receive another instrument panel that is configured to connect to the at least one additional mounting structure of the cover panel.
Clause 8: The dashboard of any of the clauses, wherein the another instrument panel comprises a touch-sensitive electronic display.
Clause 9: A personal transportation vehicle comprising: a plurality of wheels; a body supported by the plurality of wheels; at least one seat coupled to the body; a dashboard positioned to oppose the at least one seat, the dashboard including: a control port; and one or more mounting structures positioned in the control port, wherein the control port is configured to receive one of a plurality of instrument panels therein, each of the plurality of instrument panels including a unique configuration of one or more control components for operation of the personal transportation vehicle, and wherein each of the plurality of controls modules is configured to be secured within the controls port via at least one of the one or more mounting structures.
Clause 10: The personal transportation vehicle of any of the clauses, wherein the one or more control components include at least one of an electronic display, an indicator light, and a switch.
Clause 11: The personal transportation vehicle of any of the clauses, wherein the one or more mounting structures of the controls port comprises a pair of mounting brackets that align with corresponding mounting brackets on each of the plurality of instrument panels.
Clause 12: The personal transportation vehicle of any of clauses, wherein the dashboard further comprises a compartment assembly that is configured to engage with each of the plurality of instrument panels to define a compartment along a top surface of the dashboard.
Clause 13: The personal transportation vehicle of any of the clauses, wherein the compartment assembly comprises: a cover panel that is configured to be secured to the dashboard at the control port so that the cover panel is configured to at least partially cover the pair of mounting brackets; and a compartment insert that is configured to be inserted into the control port and to be connected to the cover panel to define the compartment.
Clause 14: The personal transportation vehicle of any of the clauses, wherein the compartment assembly further comprises a compartment door that configured to pivotably coupled to the dashboard along the top surface, and wherein the compartment door is configured to pivot relative to the dashboard between: a closed position in which the compartment door is rotated to engage with the compartment insert to cover the compartment; and an open position in which the compartment door is rotated upward from the closed position to expose the compartment.
Clause 15: The personal transportation vehicle of any of the clauses, wherein the dashboard further comprises a compartment assembly that is configured to define a compartment along a top surface of the dashboard in the control port, wherein the compartment assembly comprises a cover panel that is configured to connect to at least one of the one or more mounting structures of the control port, and wherein the cover panel defines at least one additional mounting structure, and wherein the control port is configured to receive an another instrument panel that is configured to connect to the at least one additional mounting structure of the cover panel.
Clause 16: The personal transportation vehicle of any of the clauses, wherein the another instrument panel comprises a touch-sensitive electronic display.
Clause 17: The personal transportation vehicle of any of the clauses, further comprising: a wire harness that is at least partially positioned in the control port, wherein the wire harness is configured to connect to each of the one or more control components of at least two of the plurality of instrument panels.
Clause 18: The personal transportation vehicle of any of the clauses, wherein the personal transportation vehicle comprises an electric vehicle.
Clause 19: The personal transportation vehicle of any of the clauses, wherein the personal transportation vehicle comprises a golf cart.
Clause 20: The personal transportation vehicle of any of the clauses, wherein the personal transportation vehicle comprises a utility vehicle.

Embodiment disclosed herein include modular dashboards that are configured to be placed in a plurality of different configurations in order to facilitate the manufacturing (or converting) of a personal transportation vehicle in (or to) a number of different configurations. For instance, in some embodiments, the modular dashboards of the embodiments disclosed herein may include a controls port that may receive a plurality of unique instrumental panels therein. Thus, a manufacturer of personal transportation vehicles may stock a single dashboard for personal transportation vehicles that are ultimately to be placed in a number of different configurations. As a result, the number of unique manufacturing components and steps may be minimized so that the overall manufacturing process for personal transportation vehicles may be more streamlined.

The preceding discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used in reference to a stated value mean within a range of plus or minus 10% of the stated value.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A dashboard for a personal transportation vehicle, the dashboard comprising:
a control port; and
one or more mounting structures positioned in the control port,
wherein the control port is configured to receive one of a plurality of instrument panels therein, each of the plurality of instrument panels including a unique configuration of one or more control components for operation of the personal transportation vehicle, and
wherein each of the plurality of controls modules is configured to be secured within the controls port via at least one of the one or more mounting structures.

2. The dashboard of claim 1, wherein the one or more control components include at least one of an electronic display, an indicator light, and a switch.

3. The dashboard of claim 2, wherein the one or more mounting structures of the controls port comprises a pair of mounting brackets that align with corresponding mounting brackets on each of the plurality of instrument panels.

4. The dashboard of claim 3, further comprising a compartment assembly that is configured to engage with each of the plurality of instrument panels to define a compartment along a top surface of the dashboard.

5. The dashboard of claim 4, wherein the compartment assembly comprises:
a cover panel that is configured to be secured to the dashboard at the control port so that the cover panel is configured to at least partially cover the pair of mounting brackets; and
a compartment insert that is configured to be inserted into the control port and to be connected to the cover panel to define the compartment.

6. The dashboard of claim 5, wherein the compartment assembly further comprises a compartment door that configured to pivotably coupled to the dashboard along the top surface, and wherein the compartment door is configured to pivot relative to the dashboard between:
a closed position in which the compartment door is rotated to engage with the compartment insert to cover the compartment; and
an open position in which the compartment door is rotated upward from the closed position to expose the compartment.

7. The dashboard of claim 2, further comprising a compartment assembly that is configured to define a compartment along a top surface of the dashboard in the control port,
wherein the compartment assembly comprises a cover panel that is configured to connect to at least one of the one or more mounting structures of the control port, and
wherein the cover panel defines at least one additional mounting structure, and wherein the control port is configured to receive another instrument panel that is configured to connect to the at least one additional mounting structure of the cover panel.

8. The dashboard of claim 7, wherein the another instrument panel comprises a touch-sensitive electronic display.

9. A personal transportation vehicle comprising:
a plurality of wheels;
a body supported by the plurality of wheels;
at least one seat coupled to the body;
a dashboard positioned to oppose the at least one seat, the dashboard including:
a control port; and
one or more mounting structures positioned in the control port,
wherein the control port is configured to receive one of a plurality of instrument panels therein, each of the plurality of instrument panels including a unique configuration of one or more control components for operation of the personal transportation vehicle, and
wherein each of the plurality of controls modules is configured to be secured within the controls port via at least one of the one or more mounting structures.

10. The personal transportation vehicle of claim 9, wherein the one or more control components include at least one of an electronic display, an indicator light, and a switch.

11. The personal transportation vehicle of claim 10, wherein the one or more mounting structures of the controls port comprises a pair of mounting brackets that align with corresponding mounting brackets on each of the plurality of instrument panels.

12. The personal transportation vehicle of claim 11, wherein the dashboard further comprises a compartment assembly that is configured to engage with each of the plurality of instrument panels to define a compartment along a top surface of the dashboard.

13. The personal transportation vehicle of claim 12, wherein the compartment assembly comprises:
a cover panel that is configured to be secured to the dashboard at the control port so that the cover panel is configured to at least partially cover the pair of mounting brackets; and
a compartment insert that is configured to be inserted into the control port and to be connected to the cover panel to define the compartment.

14. The personal transportation vehicle of claim 13, wherein the compartment assembly further comprises a compartment door that configured to pivotably coupled to the dashboard along the top surface, and wherein the compartment door is configured to pivot relative to the dashboard between:
a closed position in which the compartment door is rotated to engage with the compartment insert to cover the compartment; and
an open position in which the compartment door is rotated upward from the closed position to expose the compartment.

15. The personal transportation vehicle of claim 10,
wherein the dashboard further comprises a compartment assembly that is configured to define a compartment along a top surface of the dashboard in the control port,
wherein the compartment assembly comprises a cover panel that is configured to connect to at least one of the one or more mounting structures of the control port, and
wherein the cover panel defines at least one additional mounting structure, and wherein the control port is configured to receive an another instrument panel that is configured to connect to the at least one additional mounting structure of the cover panel.

16. The personal transportation vehicle of claim 15, wherein the another instrument panel comprises a touch-sensitive electronic display.

17. The personal transportation vehicle of claim 16, further comprising:
a wire harness that is at least partially positioned in the control port, wherein the wire harness is configured to connect to each of the one or more control components of at least two of the plurality of instrument panels.

18. The personal transportation vehicle of claim 17, wherein the personal transportation vehicle comprises an electric vehicle.

19. The personal transportation vehicle of claim 18, wherein the personal transportation vehicle comprises a golf cart.

20. The personal transportation vehicle of claim 17, wherein the personal transportation vehicle comprises a utility vehicle.
